(19) United States
(12) Patent Application Publication
(10) Pub. No.: US 2021/0229128 A1
(43) Pub. Date: Jul. 29, 2021

(54) METHOD OF MAKING A MONOLITHIC MULTI-TONE AUDIO SPEAKER COVER

(71) Applicant: OAKWOOD METAL FABRICATING CO., Dearborn, MI (US)

(72) Inventors: Donald Scott SMITH, Commerce, MI (US); Richard Francois AUDI, Dearborn, MI (US); Joel Matthew CORMIER, Lathrup Village, MI (US)

(21) Appl. No.: 16/752,437

(22) Filed: Jan. 24, 2020

(51) Int. Cl. B05D 5/06; H04R 1/02; B05D 1/32; B05D 7/00

(52) U.S. Cl. CPC B05D 5/066; B05D 7/57; B05D 1/322; H04R 1/023

(57) ABSTRACT

A method of making a monolithic multi-tone audio speaker cover. The method involves creating a hole pattern in a blank; forming a shape in the blank to make a shaped blank; treating or painting at least some of the surface of the shaped blank with a primary treatment or color to prepare a treated or painted shaped blank; masking an area of the treated or painted shaped blank with a masking material to cover at least a portion of the treated or painted shaped blank; and applying a secondary color to the unprotected area.

### TECHNICAL FIELD

The present disclosure relates to a monolithic multi-tone audio speaker cover.

### BACKGROUND ART

An audio speaker cover is often one of the first objects that an observer sees when looking toward a source of sound. The cover, also known as “cover”, is located in the front of many consumer, automotive and industrial speakers that are designed to propagate sound. Even when silent, the audio speaker cover usually contributes one way or another to an overall visual impression of an environment of use.

Speakers are typically housed in a speaker enclosure, casing or cabinet. The enclosure's materials and design influence the quality of the sound. The enclosure generally must be as stiff and non-resonant as practically possible.

The audio speaker cover usually has a hard or soft screen that is mounted over the face of a speaker driver. Its main purpose is to protect internal speaker components from damage while allowing sound to pass without excessive loss or distortion. However, because the cover lies in the path of the sound waves, the cover inevitably influences the sound produced, often detrimentally.

A balance is therefore sought between ability to protect the speaker and sound quality. If the cover is massive, sound quality is impaired. But potentially ugly components may be effectively masked from view. On the other hand, if the cover is too flimsy, unsightliness may result. However sound quality may be relatively unaffected.

Against such design challenges, audio speaker covers have been manufactured from a variety of materials including fabric, thermoplastics, thermosets, perforated metal, expanded metal, woven wire, and the like. Certain materials such as fabric may be thin and have a large open area percentage. This may be ideal for sound transmission. But these materials lack the ability to adequately protect the speaker assembly in environments where human contact and abuse is anticipated. Examples include home audio systems, electronic devices, computers, microphones, portable speakers, and transportation-related audio systems such as cars, trucks, boats, aircraft and the like.

In such applications, substantially rigid audio speaker covers are deployed adjacent to the speaker itself to protect the fragile speaker cone and assembly from damage. Additionally, since these systems are in proximity to the audiophile, visual styling and aesthetics are also necessary in order to produce a cost-effective yet attractive means of protecting the speaker itself.

Speaker covers may be injection molded from thermoplastics. However, plastics have a lower strength to weight ratio compared to metal speaker covers and therefore require substantially more thickness than a metal cover to protect the speaker assembly.

Metal speaker covers have historically offered superior sound transmission characteristics compared to plastic speaker covers due to their high strength to weight ratio. Metal audio covers can be produced from a variety of metals including woven metal wire and with sheets of metal which are subject to a variety of processes to create apertures for sound transmission. These sheet-based processes include metal expanding, punch perforating, laser cutting, water jet cutting, photochemical etching, and powdered metal laser sintering. Sheets of these materials with apertures are then converted in finished goods using traditional metal forming techniques combined with a variety of coating and finishing techniques. However, the finished speaker cover needs to be visually pleasing to the audiophile. The penalty for adding a cover is always the amount of sound transmission loss due to solid or the non-open area of the rigid speaker cover that protects the speaker.

The ideal audio speaker cover is both attractive and cost effective to manufacture along with providing adequate strength that withstands normal abuse and offers the lowest possible sound transmission loss. Metal speaker covers have traditionally offered the best balance of strength and lower levels of sound transmission loss than compared to injection molded speaker covers.

### SUMMARY

In several aspects, this disclosure includes a method of making a multi-tone monolithic audio speaker cover. In broad terms, one way to do this is by following such steps as:
a. creating a hole pattern in a blank and treating the blank if desired to impart a desired surface finish, tone or color;
b. forming a shape in the blank to make a shaped blank;
c. treating at least some of the surface of the shaped blank with a primary treatment or color to prepare a treated shaped blank;
d. masking an area of the treated shaped blank with a masking material to cover at least a portion of the treated shaped blank, thereby defining a protected area of the shaped blank that underlies a masking material and lies adjacent to an unprotected area of the shaped blank;
e. applying a secondary treatment or color to the unprotected area;
f. optionally, re-masking, re-treating and/or re-painting if one or more additional surface treatments or colors are required; and
g. removing the masking material to define in the audio speaker cover a distinct border between the primary and secondary treated or colored areas.

Multi-toned audio speaker covers made by such process steps (1) have a surface that is free of blemishes or deformation; (2) are visually pleasing; and (3) are of one-piece construction. As a result of one-piece construction, manufacturing efficiencies are realized. Further, the audio speaker cover is relatively immune to problems of squeaks and rattles that often accompany multi-piece assemblies of audio speaker cover assemblies (e.g. at a chrome border of a conventional cover).

The above advantage and other advantages and features of the present disclosure will be readily apparent from the following detailed description of the preferred embodiments when taken in connection with the accompanying drawings.

### BRIEF DESCRIPTION OF THE DRAWINGS

FIG. 1 includes a side view of a blank from which an audio speaker cover is to be made, before shaping, a plan view of a shaped audio speaker cover and a sectional view thereof;

FIG. 2 is a representative method of making process flow diagram;

FIG. 3 is a plan view of an audio speaker cover upon which an alternative masking approach is used;

FIG. 4 is a sectional view of a finished audio speaker cover

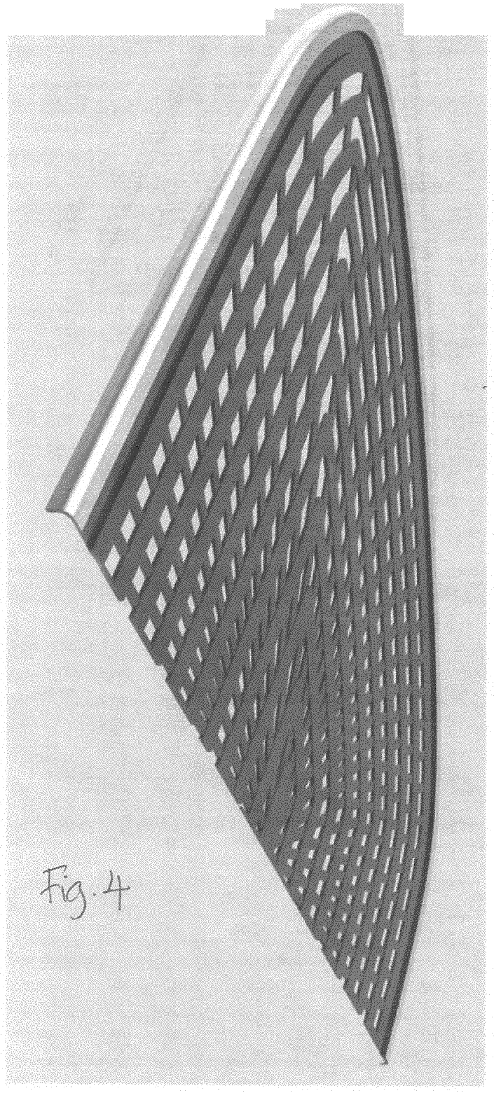

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As those of ordinary skill in the art will understand, various features of the present invention as illustrated and described with reference to any one of the Figures may be combined with features illustrated in one or more other Figures to produce embodiments of the present disclosure that are not explicitly illustrated or described. The combinations of features illustrated provide representative embodiments for typical applications. However, various combinations and modifications of the features consistent with the teachings of the present disclosure may be desired for particular applications or implementations.

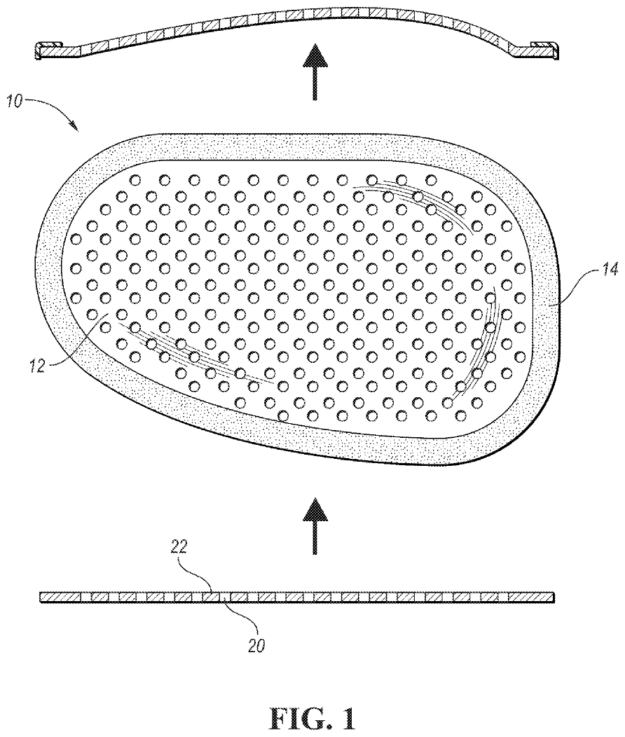

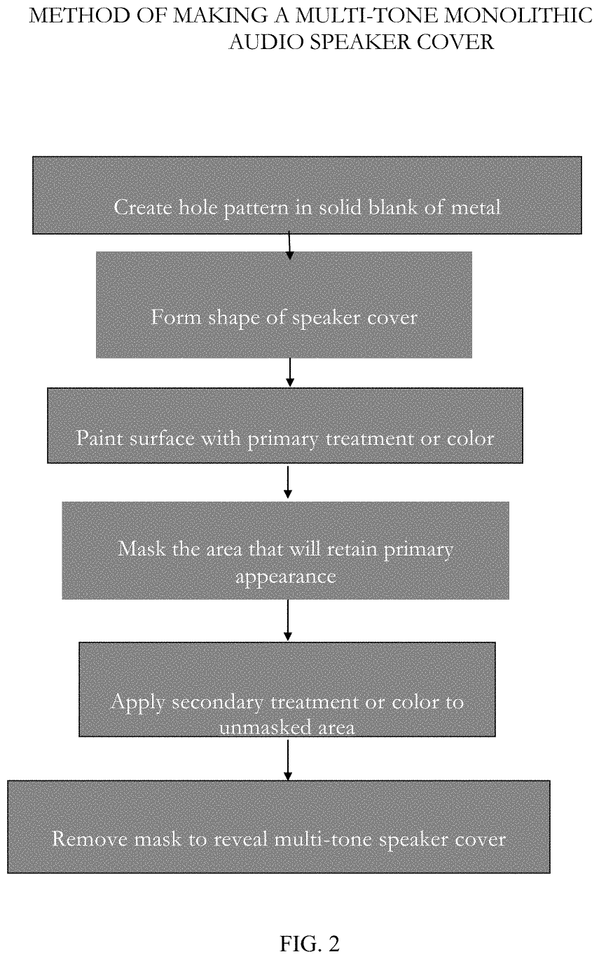

Turning first to FIGS. 1-2, there are depicted various aspects of representative embodiments of an audio speaker cover 10 with a central region 12 and a peripheral region 14. In some embodiments, the central region has a generally planar surface. In other embodiments the central region 12 may be convex or concave.

In a preferred embodiment, the audio speaker cover 10 defines a plurality of apertures 20. Lands 22 lie between at least some of the apertures 20.

With primary reference to FIG. 1, the central region 12 of the audio speaker cover 10 can be imagined to have an area (A), the masked (protected) area 14 to have a total area (P) and an unmasked (unprotected) area (U), such that

A=P+U.

One approach is to have the protected area deployed around edge regions of the audio speaker cover. In such cases, P approximates to about 5-20 percent of A.

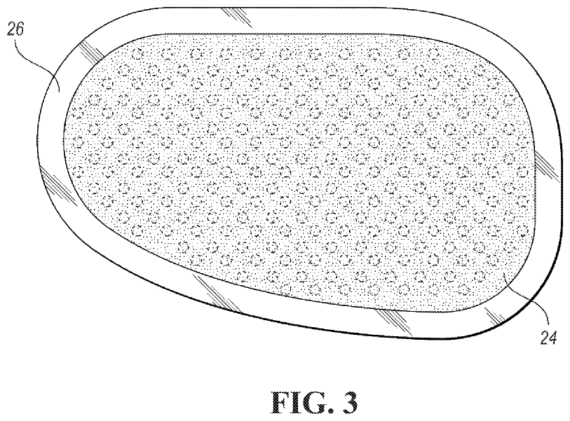

FIG. 3 illustrates an alternative approach to making a multi-tone audio speaker cover 10. In such embodiments the masking material 24 protects a central, rather than a peripheral region of the shaped speaker cover, and the unprotected area 26 lies around the periphery of the shaped speaker cover.

It will be appreciated that further alternative speaker cover appearances can be created by suitable deployment of masking material and selection of surface treatments. Such appearances could for example include islands of a secondary treatment, tone or color positioned atop a base of a primary treatment or color. As used herein “treatment” or “treating” includes painting, anodizing, burnishing, anodizing with a tinted anodizing solution, plastic vapor deposition coating and other thin film deposition techniques.

In more process detail (see, e.g., FIG. 2), exemplary ways to make the desired audio speaker covers might involve the following process steps:

a. creating a hole pattern in a blank—this step may begin with taking a solid blank of for example stainless steel or aluminum or a ceramic. materials include low carbon steel (hot or cold rolled), plastics, carbon fiber and other ceramics. Representative thicknesses may be about 0.010-0.030 inches. The individual holes may be slotted, rounded or a combination thereof. One, but not the only way to form such holes may be by acid etching. Optionally the surface of the blank may be treated before subsequent handling, e.g. by burnishing to impart a textured appearance.
b. forming a shape in the blank to make a shaped blank—this step may call for a planar or convex-shaped central region. The footprint or periphery may be of any desired shape, e.g., circular, oval, quadrilateral, etc.
c. treating at least some of the surface of the shaped blank with a primary treatment or color to prepare a treated or painted shaped blank—this step may call for applying a clear coat by conventional techniques. In this step, usually the entire surface of the outer-facing side of the speaker cover is treated.
d. protecting an area of the treated shaped blank with a masking material to cover at least a portion of the treated shaped blank, thereby defining a protected area of the treated shaped blank that underlies a masking material and lies adjacent to an unprotected area of the treated shaped blank;
e. applying a secondary treatment or color (e.g. a darker color) to the unprotected area. In such cases, a two-tone effect is created in which the periphery is of a lighter surface appearance than the central region, which is darker.
f. optionally, re-masking and re-treating or re-painting if one or more additional surface textures or colors are required; and
g. removing the masking material to define a distinct border between the primary and secondary treated or colored areas. Optionally a “ditch” or raised region may be formed to demarcate the primary and secondary areas, thus forming a break point or visual separation therebetween.

Manufacturing economies are realized by practicing such process steps. A one-piece audio speaker cover is created without needing to follow more numerous process steps in which for example a chrome periphery circumscribes a central region. Further, problems associated with buzzes, squeaks and rattles in a multi-piece assembly are avoided.

It will be appreciated that in some embodiments, the central region 12 may be convex, bulging outwardly. Alternatively, the central region 12 may be substantially concave or planar.

Preferably, the speaker cover 10 has an outer surface that is substantially free of unwanted blemish or tarnish produced by manufacturing ideosynchrasies.

While the best mode has been described in detail, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments discussed herein that are described as less desirable than other embodiments or prior art implementations with respect to one or more characteristics are not outside the scope of the disclosure and may be desirable for particular applications.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

TABLE OF REFERENCE NUMBERS

| Reference No. | Component |
|---|---|
| 10 | Speaker Cover |
| 12 | Central Region |
| 14 | Peripheral Region |
| 20 | Apertures |
| 22 | Lands |

1. A method of making a multi-tone monolithic audio speaker cover, the audio speaker cover cooperating with a housing and an audio speaker mounted in the housing, the method comprising the steps of:
creating a hole pattern in a blank, the blank having a perimeter that at least partially overlaps the audio speaker;
forming a shape in the blank to make a shaped blank;
providing a ditch around a peripheral inboard region of the shaped blank, the ditch having an edge that demarcates primary and secondary areas of the shaped blank;
treating at least some of the surface of the shaped blank with a primary treatment or color to prepare a treated shaped blank;
shielding an area of the treated shaped blank with a masking material that covers at least a portion of the treated shaped blank, thereby defining a protected area of the treated shaped blank that underlies the masking material, the protected area lying adjacent to an unprotected area of the treated shaped blank, the masking material extending to an edge of the ditch;
applying a secondary treatment or color to the unprotected area;
optionally, re-masking, re-treating and re-painting if one or more additional treatments or colors or tones are required; and
removing the masking material without deteriorating the protected area to define a distinct border along the edge of the ditch between the primary and secondary treatments or colors or tones, thereby creating an audio speaker cover that is free of blemishes and has a break point or visual separation between the primary and secondary treatment or tones or colors that is visually pleasing.

2. The method of claim 1, wherein the blank includes a material selected from the group consisting of stainless steel, low carbon steel that is hot- or cold-rolled, aluminum, plastic, wood, carbon fiber and another ceramic.

3. The method of claim 1, wherein the multi-tone audio speaker cover includes a two-tone audio speaker cover.

4. The method of claim 1, wherein the shaped blank includes a central region that is partially convex.

5. The method of claim 1, wherein the shaped blank includes a central region that is substantially planar.

6. The method of claim 1, wherein the shaped blank includes a periphery that has a configuration selected from the group consisting of round, quadrilateral, trapezoidal, oval and combinations thereof.

7. The method of claim 1, wherein the treatment step calls for treating at least a part of one side of the shaped blank with a primary finishing material.

8. The method of claim 7, wherein the primary finishing material is a clear coat.

9. The method of claim 1 wherein the masking step involves covering a peripheral region of the shaped blank.

10. The method of claim 1 wherein the masking step involves covering a central region of the shaped blank.

11. The method of claim 1, wherein the primary treatment or color is darker than the secondary treatment or color.

12. A multi-tone monolithic audio speaker cover made by the method of claim 1.

13. An audio speaker cover that is multi-toned and monolithic made by the method of claim 1.
